(19) United States
(12) Patent Application Publication
(10) Pub. No.: US 2004/0245182 A1
(43) Pub. Date: Dec. 9, 2004

(54) Multiphase fluid conveyance system

(76) Inventors: David Eric Appleford, Essex (GB); Brian William Lane, Essex (GB)

Correspondence Address: SUMMA & ALLAN, P.A., 11610 NORTH COMMUNITY HOUSE ROAD, SUITE 200, CHARLOTTE, NC, 28277, US

(21) Appl. No.: 10/491,874

(22) PCT Filed: Oct. 11, 2002
(86) PCT No.: PCT/GB02/04636

(30) Foreign Application Priority Data
Oct. 12, 2001 (GB) 0124614.9

(51) Int. Cl. C02F 1/00

(52) U.S. Cl. 210/739; 210/96.1; 210/747; 210/170; 137/1

(57) ABSTRACT

A mixture of fluids is conveyed from a hydrocarbon reservoir and comprises gas and slugs of liquid. The mixture is passed through a slug catcher vessel (12) which temporarily retains the slugs of liquid. The gas is passed through a gas compressor (18) and the resulting pressurised gas is then conveyed to a remote location. When a liquid slug is detected in the slug catcher vessel (12), liquid is drawn from the vessel by an injector device (24) and entrained into the flow of gas downstream of the gas compressor (18) until the level of the interface between the gas and liquid in the vessel reaches a sufficiently low level. The system may alternatively be configured to accommodate a flow of liquid containing slugs of gas.

The present invention relates to the conveyance of multiphase fluid mixtures and more particularly the conveyance by means of a liquid pump or gas compressor of hydrocarbon well production fluids.

Production fluid from a hydrocarbon reservoir generally comprises a mixture of liquid and gas fluid phases. The fluid may comprise mainly liquid in the form of oil and produced water with a certain amount of gas or mainly hydrocarbon gas with a certain amount of liquid mixed therein. When reservoir pressure is low so-called slug flow may occur i.e. mainly liquid with slugs of gas as a result of gas breaking out of solution. Likewise a mainly gas flow may contain slugs of liquid. In a situation in which the reservoir pressure is insufficient to drive the produced fluid towards a remote location, for example a host facility, at a sufficiently high rate, it is necessary to boost its pressure. In the case of a flow which is mainly gas, this might be effected by means of a gas compressor and in the case of a flow which is mainly liquid, this might be effected by means of a multiphase pump. Most items of equipment associated with fluid pressure boosting, such as gas compressors and multiphase pumps, have a range of inlet conditions (e.g. gas to liquid ratio) which must not be exceeded if satisfactory operation is to be ensured. For some equipment items, this range of inlet conditions is fairly narrow, which presents problems when the multiphase production fluid from a reservoir exhibits slug flow conditions or reservoir characteristics change over a period of time.

The object of the invention is to at least partially alleviate the above problem and thereby extend the range of inlet conditions which a system incorporating such items of equipment can handle effectively.

Thus, according to the invention, there is provided a method of conveying a mixture of fluids from a hydrocarbon reservoir containing a first fluid substantially in one of a gaseous phase or a liquid phase and second fluid substantially in the other phase, comprising:

(i) passing the mixture through a separation means which substantially separates the first fluid from the second fluid;

(ii) passing the first fluid through a device which raises its pressure; and

(iii) conveying the pressurised first fluid to a remote location.

With the above method, the pressure raising device is not exposed to slugs for example of fluid having a fluid phase for which it is not designed to operate.

The method may also include the step of conveying the second fluid away from equipment including the separation means and pressure raising device independently of the first fluid. When the second fluid is substantially in liquid phase, it is preferably passed through a pressurising means such as a pump prior to such conveyance.

Alternatively, the second fluid may be routed from the separation means and mixed with the first fluid downstream of the pressure raising device. Such an arrangement will benefit from only needing a single pipe to convey the first and second fluids to the remote location.

The mixing of first and second fluids may conveniently be by means of an injector device which may be arranged to entrain the second fluid in a relatively low pressure region thereof.

The flow of the second fluid from the separation means is preferably controlled by means of a flow control valve which is advantageously electrically actuated so that it can respond sufficiently quickly when a slug of the second flow enters the separation means or when an abrupt increase in the percentage of the second fluid in the mixture entering the separation means occurs.

The flow of the first fluid from the separation means may also be controlled by a further flow control valve which is also preferably electrically actuated for the same reason as for the flow control valve regulating the flow of the second fluid.

When the first fluid is a gas, the pressure raising means is preferably a gas compressor and when it is a liquid, the pressure raising means is preferably a multiphase pump.

The separation means conveniently comprises a slug catching vessel which separates the first and second fluids as a consequence of their different specific gravities.

The method preferably includes the step of sensing the relative amounts of first and second fluids in the separation means and controlling the flows of the first and/or second fluids from the separation means in a manner dependent on the sensed relative amounts. Depending on the sensed relative amounts of the fluids in the separation means, at least a portion of one said fluid from the separation means may be recirculated back into the separation means.

The relative amounts of first and second fluids in the separation means is preferably sensed by a level sensor which detects where an interface between the first and second fluids is situated.

The imminent arrival, in the separation means, of a slug of the second fluid may be detected by a slug detection device situated upstream of and close to the separation means.

The method may include the step of transmitting signals relating to the content of the mixture approaching or in the separation means to control means which provides signals for actuating devices for controlling the flows of one or both of the fluids from the separation means. The actuating devices may comprise the flow control valves mentioned earlier.

According to a second aspect of the invention there is provided a system for conveying a first fluid, substantially in one of a liquid or gaseous phase, and which is originally in a mixture with a second fluid substantially in the other phase to a remote location including a separation means configured to substantially separate the first fluid from the second fluid, a device for raising the pressure of the first fluid and conveying means for conveying the separated and pressurised first fluid to the remote location. The system may include other features referred to above.

The invention will now be described by way of example only with reference to the accompanying schematic figures in which:

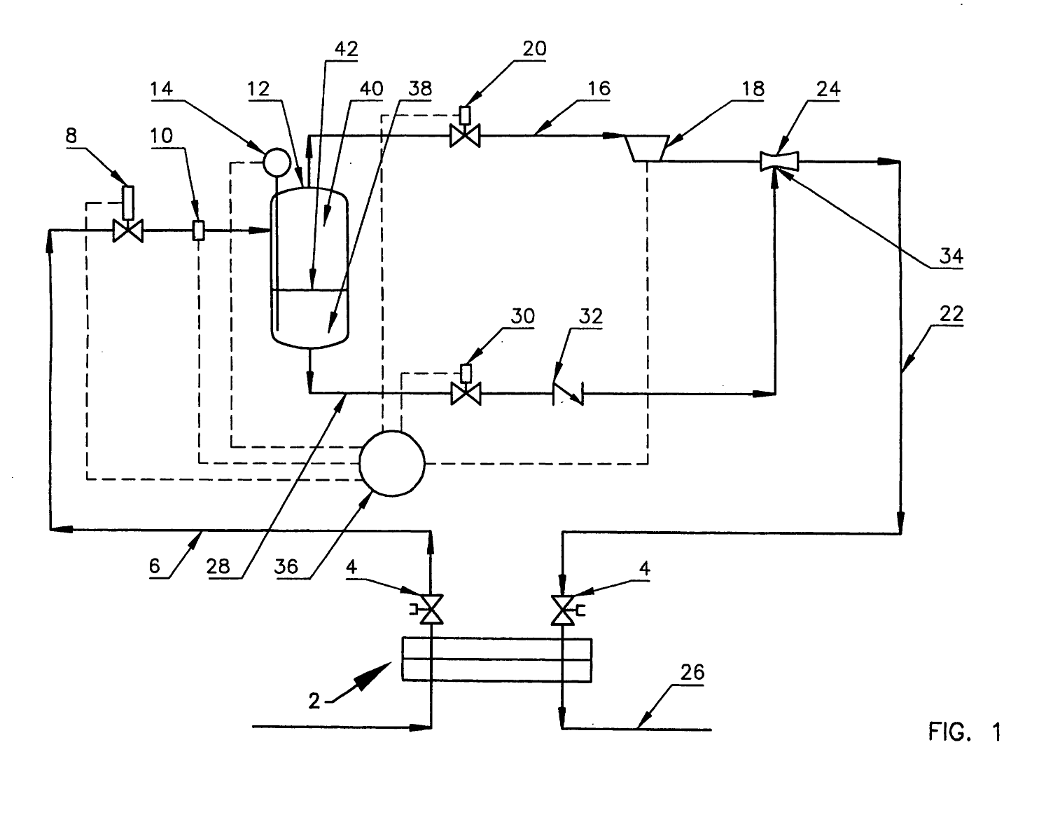

FIG. 1 shows a first embodiment of the invention;

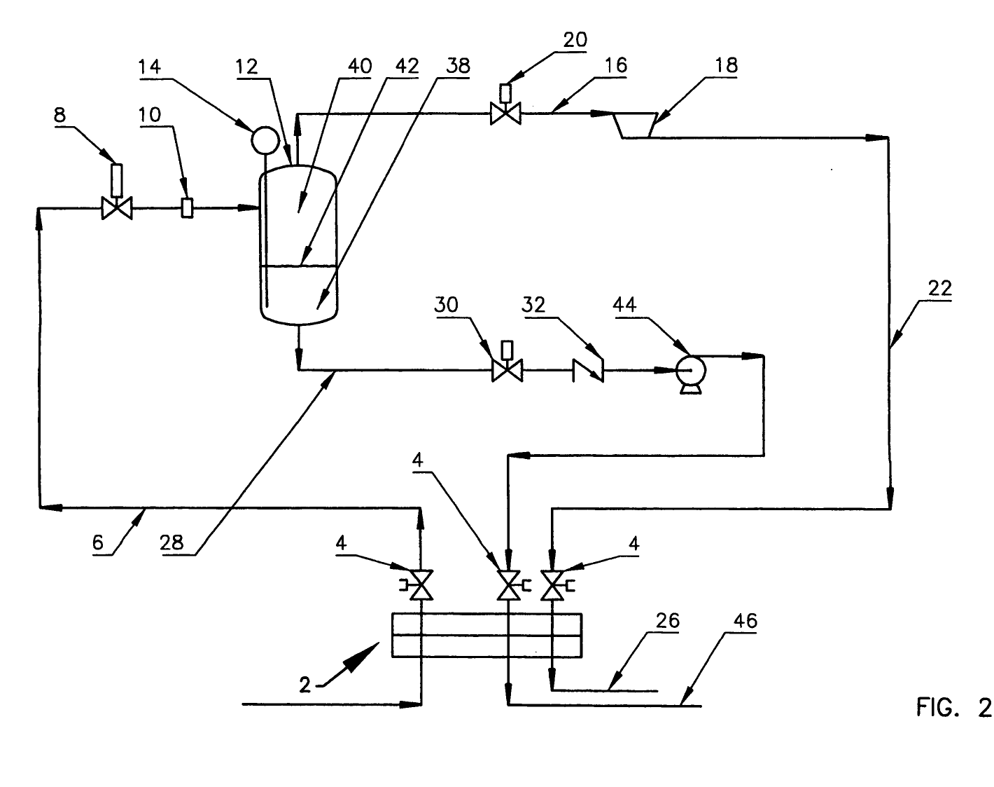

FIG. 2 shows a second embodiment of the invention;

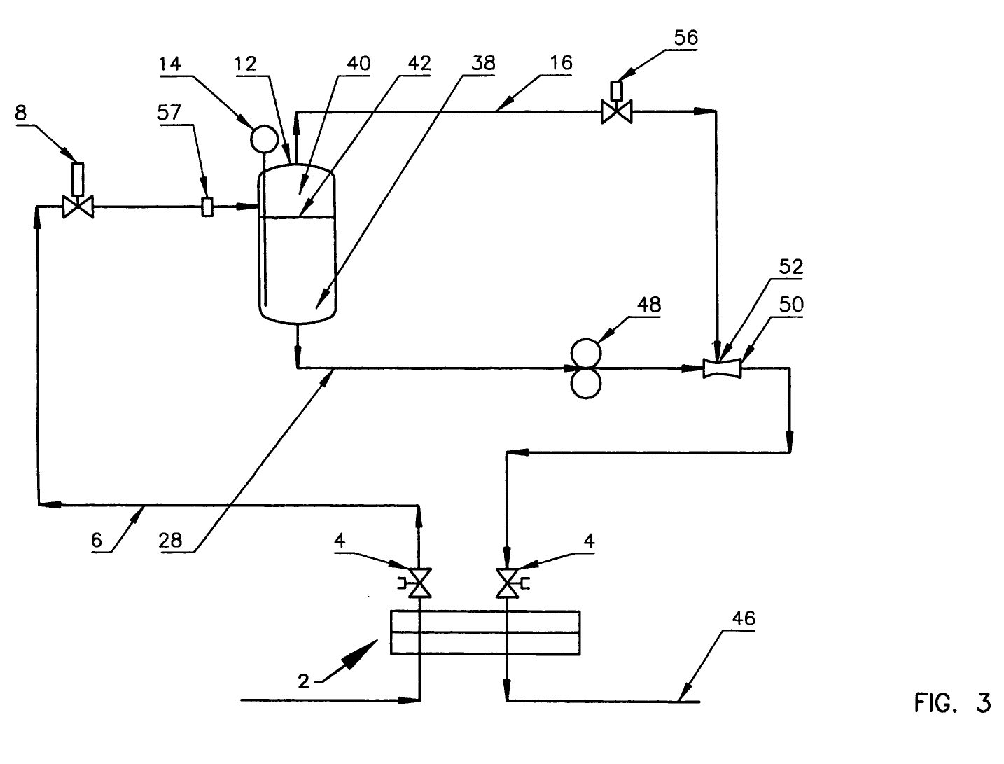

FIG. 3 shows a third embodiment of the invention;

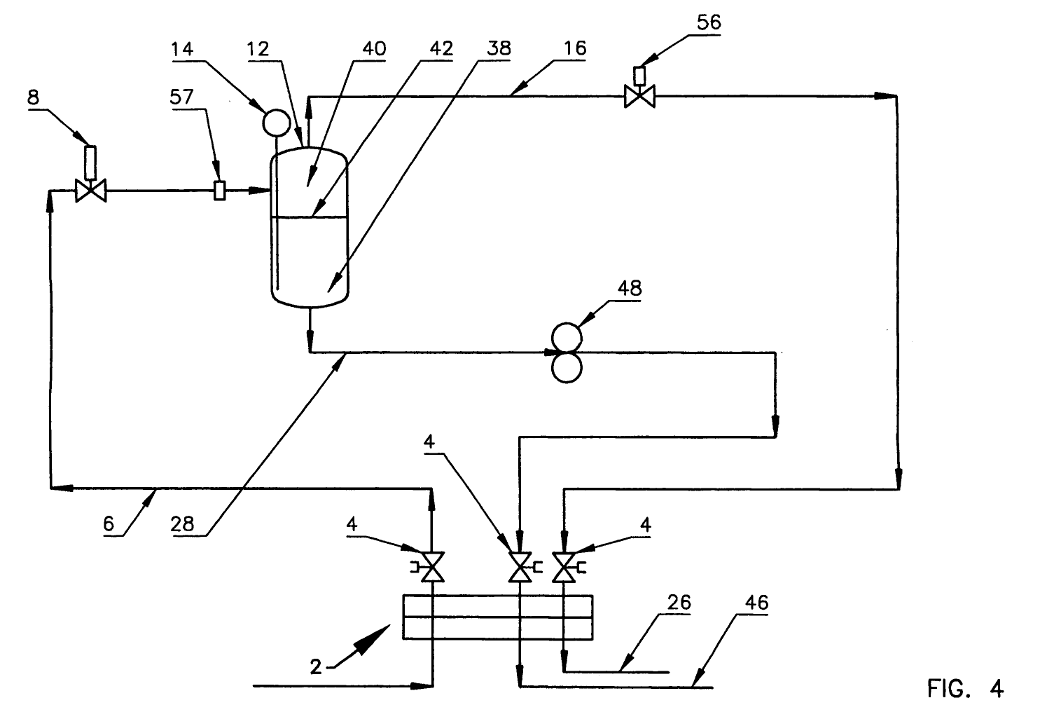

FIG. 4 shows a fourth embodiment of the invention; and

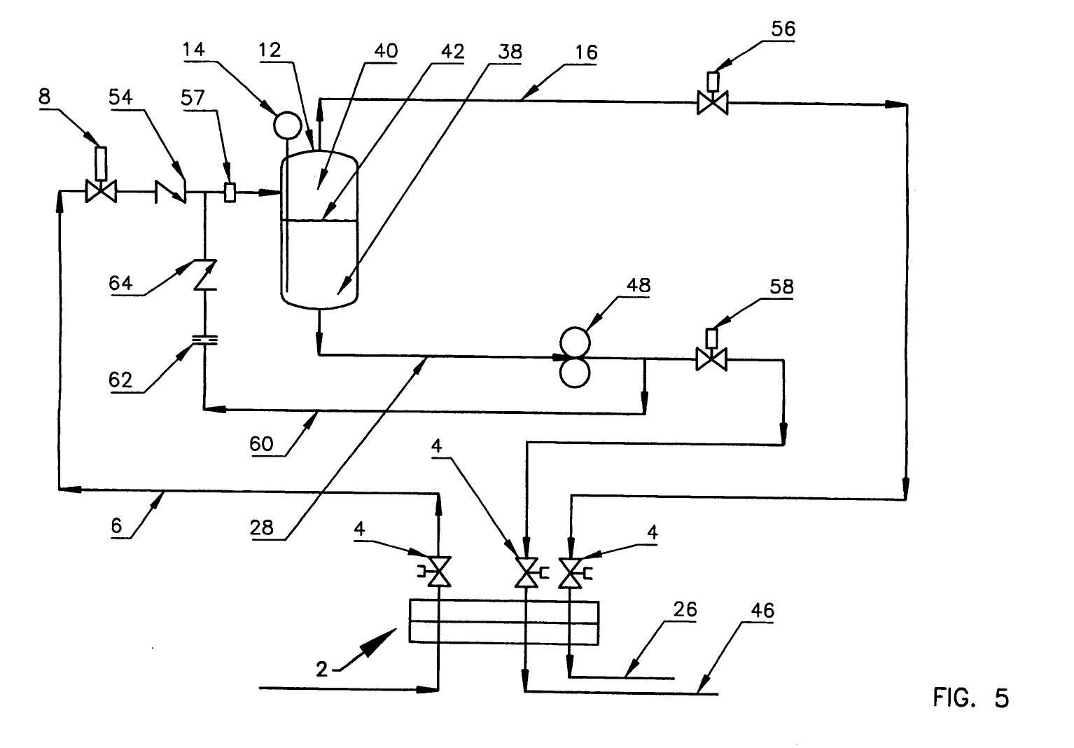

FIG. 5 shows a fifth embodiment of the invention.

In the figures, like numerals are used to designate like parts and the description of a particular part applies to correspondingly numbered parts in different figures unless otherwise stated.

The first embodiment of the invention shown in FIG. 1 comprises a system for conveying a mixture mainly comprising gas but containing slugs of liquid to a remote location. The system may be accommodated in a module which is connected to a subsea system by means of a multi-ported fluid connector 2 which includes isolation valves 4. The module may be of the general type forming part of the system designed by Alpha Thames Limited of Essex, United Kingdom and named AlphaPRIME. An inlet pipe 6 leads from the connector 2 through a fail-safe isolation valve 8 and a slug detector device 10 to a separation means in the form of a slug catcher vessel 12 containing a level sensor 14. A gas outlet pipe 16 opening into an upper part of the vessel 12 leads to a pressure raising device comprising a gas compressor 18 via a flow control valve 20. A compressed gas pipe 22 leads from an outlet of the gas compressor 18 via an injector device 24 to one of the isolation valves 4 of the connector 2 for connection with a gas pipeline 26 leading away from the system.

A liquid outlet pipe 28, opening into a lower region of the vessel 12, leads via a flow control valve 30 and a one way valve 32 to an intake port 34 of the injector device 24 which is configured to entrain liquid from the pipe 28 into the flow of pressurised gas.

The components 8, 10, 14, 18, 20 and 30 are all connected by signal lines (shown dotted) to a power and control pod 36.

The slug catcher vessel 12 is shown containing liquid 38 (e.g. an oil and water mixture) and gas 40 with an interface 42 therebetween.

The operation of the system depicted in FIG. 1 will now be described.

Gas entering the system through the fluid connector 2 passes through the inlet pipe 6 and into the slug catcher vessel 12 from where it is routed via the gas outlet pipe 16 and gas compressor 18 to the injector device 24. The compressed gas then flows through the compressed gas pipe 22 to the fluid connector 2 where it enters the gas pipeline 26 for conveyance to a remote location.

When a slug of liquid enters the inlet pipe 6, it is retained by the slug catcher vessel 12. The consequent rise in the interface 42 is sensed by the level sensor 14 which sends a signal to the pod 36. This rapidly results in a partial closing of control valve 20 in the gas outlet pipe 16 and at least a partial opening of the valve 30 which results in liquid being drawn by the injector device 24 from the vessel 12 and through the one way valve 32. The use of electrical actuators for controlling the control valves 20 and 30 permits them to be opened very rapidly. For this reason, the vessel 12 does not have to be sufficiently large to accommodate the full volume of a typical liquid slug (as is the case for existing slug catcher vessels employed at host facilities typically situated on surface facilities or ashore). The reduced volume of the slug catcher vessel 12 makes it particularly suitable for subsea use and permits its wall thickness to be reduced, thus saving weight and cost. Liquid is accordingly entrained by the injector 24 into the flow of gas downstream of the compressor 18 until the level of the interface 42 in the vessel 12 reaches a sufficiently low level, at which point the control valve 30 is closed and the control valve 20 is opened.

The pod 36 may include means to adjust the extent to which the valves 20 and 30 are opened/closed in a manner which is dependent on the level of the interface 42.

The liquid slug is accordingly passed into the gas pipeline 26 for conveyance to the remote location without passing through the gas compressor 18. For this reason, as the production fluid mixture being handled by the system progressively contains more liquid slugs or has a higher liquid content (as the associated production well ages), a particular gas compressor with a given liquid percentage tolerance can be employed for longer than if the above described system was not employed. This will accordingly increase financial viability and extend the period over which the gas compressor can be used.

The power and control pods included in the systems depicted in FIGS. 2, 3 and 4 and the connections between the system components (e.g. valves, pumps, sensors, detection devices etc.) have been omitted for the sake of clarity.

The second embodiment of the invention depicted in FIG. 2 differs from that depicted in FIG. 1 in that, after the one way valve 32, the liquid outlet pipe 28 is routed through a pump 44, the output of which leads to the fluid connector 2 where it communicates with a separate liquid pipeline 46 which routes the liquid to the remote location independently of the gas in the gas pipeline 26. If the pressure of liquid in the liquid outlet pipe 28 is sufficiently high, then the pump 44 may not be necessary.

Apart from the routing of the liquid, the system depicted in FIG. 2 operates in the same way as that depicted in FIG. 1.

The third embodiment of the invention depicted in FIG. 3 differs from that depicted in FIG. 1 in that the main flow from the vessel 12 comprises the liquid flow and accordingly the liquid outlet pipe 28 includes a multiphase pump 48 and an injector device 50 with an inlet 52 which entrains gas (rather than liquid as in the case of injector device 24) from the gas outlet pipe 16 into the liquid flowing through the injector 50.

Under normal flow conditions, liquid enters the system through the inlet pipe 6 and is routed through a slug detection device 57 (which is adapted to detect slugs of gas rather than liquid as in the case of slug detection device 10) into the slug catcher vessel 12 from where it is pumped by the multiphase pump 48 through the liquid outlet pipe 28 and the injector 50 to the fluid connector 2 and into the liquid pipeline 46 for conveyance to the remote location.

When a slug of gas enters the inlet pipe 6, it passes into the vessel 12 causing a fall of the interface 42. This fall is sensed by the level sensor 14 which sends a signal to the pod 36 which sends a signal to rapidly at least partially open the control valve 56 which permits gas to be drawn by the injector 50 from the vessel 12 and through the gas outlet pipe 16. This gas is drawn through the injector inlet 52 where it mixes with the pressurised liquid and flows with it to the fluid connector 2 where the mixture of liquid and gas enter the liquid pipeline 46 for conveyance to the remote location.

Once the interface 42 has risen sufficiently, as sensed by the level sensor 14, the control valve 56 is closed. The extent to which the control valve 56 is opened will be controlled by the pod 36 in dependence of the level of interface 42.

The fourth embodiment of the invention depicted in FIG. 4 differs from the embodiment depicted in FIG. 3 in that the liquid output pipe 28 does not include an injector 50 and the gas output pipe 16 leads from the control valve 56 directly to the fluid connector 2 where it is connected to a separate gas pipeline 26 for conveying the gas to the remote location separately from the liquid in the liquid pipeline 46.

The fifth embodiment of the invention depicted in FIG. 5 differs from the embodiment depicted in FIG. 4 in that a flow control valve 58 is situated downstream of the multiphase pump 48. A non-return valve 54 is situated downstream of the isolation valve 8 and a recirculation pipe 60 connects a point on the liquid outlet pipe between the multiphase pump 48 and flow control valve 58 to a point on the inlet pipe 6 between the isolation valve 8 and the slug detection device 57. The recirculation pipe 60 contains a flow restriction device 62 and a non-return valve 64.

If the interface 42 in the slug catcher vessel 12 falls below a predetermined level, as an alternative to or in addition to slowing the multiphase pump 48 the flow control valve 58 can be at least partially closed which will force liquid from the liquid outlet pipe 28 through the recirculation pipe 60 and back into the vessel 12. This may be necessary if it is not possible to slow the multiphase pump 48 rapidly enough and will assist in keeping the volumetric requirement for the vessel 12 lower than it might be.

The additional features referred to in the paragraph above could equally be applied to the embodiments depicted in FIGS. 1 to 3.

Signals from the slug detection devices 10 and 57 may be used in addition to or instead of those from the level sensor 14 to trigger the release of slug fluid from the vessel 12.

It will be apparent to a skilled person in the art that the advantages discussed in connection with the system depicted in FIG. 1 will apply in a corresponding manner to the systems depicted in the other figures. It will also be apparent that certain system variants may be incorporated without departing from the scope of the invention.

1. A method of conveying a mixture of fluids from a hydrocarbon reservoir containing a first fluid substantially in one of a gaseous phase or a liquid phase and second fluid substantially in the other phase, comprising passing the mixture through a separation means (12) which substantially separates the first fluid from the second fluid, passing the first fluid through a device (18) which raises its pressure, and conveying the pressurized first fluid to a remote location, and characterized by the step of routing the second fluid from the separation means (12) so as to be mixed with the first fluid downstream of the pressure raising device (18) by means of an injector device (24) which is arranged to entrain the second fluid in a relatively low pressure region thereof.

2. A method as claimed in claim 1, including the step of conveying the second fluid away from equipment including the separation means (12) and pressure raising device (18) independently of the first fluid).

3. A method as claimed in claim 2, wherein the second fluid being substantially in liquid phase, is passed through a pressurizing means (44) prior to such conveyance.

4. A method as claimed in claim 1, wherein the first fluid comprises a gas and the pressure raising device comprises a gas compressor (18).

5. A method as claimed in claims 1, wherein the first fluid comprises a liquid and the pressure raising device comprises a multiphase pump (48).

6. A method as claimed in claim 1, wherein the separation means comprises a slug catching vessel (12) which separates the first and second fluids as a consequence of their different specific gravities.

7. A method as claimed in claim 1, including the steps of sensing the relative amounts of first and second fluids in the separation means (12), and controlling the flows of the first and/or second fluids from the separation means (12) in a manner dependent on the sensed relative amounts.

8. A method as claimed in claim 7, including recirculating at least a portion of one said fluid from said separation means (12) back into the separation means, the step of recirculating being dependent on the sensed relative amounts of said first and second fluids in the separation means (12).

9. A method as claimed in claim 7, wherein the relative amounts of first and second fluids in the separation means (12) is sensed by a level sensor (14) which detects where an interface between the first and second fluids is situated.

10. A method as claimed in claim 1, including detecting the imminent arrival, in the separation means (12), of a slug of the second fluid by a slug detection device (10) situated upstream of and close to the separation means (12).

11. A method as claimed in claim 1, including the step of transmitting signals relating to the content of the mixture approaching or in the separation means (12) to control means (36) which provides signals for actuating devices (20,30) for controlling the flows of one or both of the fluids from the separation means (12).

12. A method as claimed in claim 1, wherein the flow of the first fluid from the separation means (12) is controlled by means of a flow control valve (20).

13. A method as claimed in claim 1, wherein the flow of the second fluid from the separation means (12) is controlled by means of a flow control valve (30).

14. A method as claimed in claims 11, wherein the actuating devices comprise said flow control valves (20,30).

15. A method as claimed in claim 12, wherein at least one said flow control valve (30) is electrically actuated. 16. A system for conveying a first fluid, substantially in one of a liquid or gaseous phase, and which is originally in a mixture with a second fluid substantially in the other phase to a remote location, the system including a separation means (12) configured to substantially separate the first fluid from the second fluid, a device (18) for raising the pressure of the first fluid, and conveying means (22,26) for conveying the separated and pressurized first fluid to the remote location, and characterized by routing means (28) for routing the second fluid from the separator means (12) so as to be mixed with the first fluid at an injector device (24) downstream of the pressure raising device (18) and arranged to entrain the second fluid in a relatively low pressure region thereof.
